(19) United States
(12) Patent Application Publication
(10) Pub. No.: US 2016/0269340 A1
(43) Pub. Date: Sep. 15, 2016

(54) MESSAGE NOTIFICATION SYSTEM

(71) Applicant: Nelfor S.A., Montevideo (UY)

(72) Inventor: Federico Nano, Buenos Aires (AR)

(73) Assignee: Nelfor S.A., Montevideo (UY)

(21) Appl. No.: 14/645,192

(22) Filed: Mar. 11, 2015

(51) Int. Cl. H04L 12/58; G06F 3/0482; G06F 3/0484; H04L 29/08

(52) U.S. Cl. CPC H04L 51/24; H04L 51/22; H04L 67/10; G06F 3/0482; G06F 3/04842; H04L 67/306; H04L 51/12

(57) ABSTRACT

A method including: receiving a message configuration; selecting one or more recipients from among users based on the one or more targeting filters and first profile information about the users; determining one or more communication channels for delivery of the messages to the one or more recipients based on the one or more channel selections and second profile information about each of the one or more recipients; adapting the inputted message for delivery in the first message format and a second message format different from the first message format; determining when to send a first message and the second message based on the one or more triggering conditions; and sending at least one of the first message or the second message through the one or more communication channels to the one or more recipients. Other embodiments are provided.

### TECHNICAL FIELD

This disclosure relates generally to communications through communication channels, and relates more particularly to selecting communication channels and delivering messages adapted to those channels.

### BACKGROUND

Communications through digital communication channels to individual recipients have become ubiquitous. There are now many different digital communication channels available. However, communications are often not opened, read, and/or viewed by the intended recipients at the time intended by the senders of the communications. Further, the type of content intended to be sent in the communications can limit the choice of digital communication channels used by the senders.

### BRIEF DESCRIPTION OF THE DRAWINGS

To facilitate further description of the embodiments, the following drawings are provided in which:

FIG. 1 illustrates a block diagram of an exemplary system, according to an embodiment;

FIG. 2 illustrates an exemplary user interface display, as displayed on the sender device of FIG. 1;

FIG. 3 illustrates a block diagram of the external system of FIG. 1 and the message processing and delivery system of FIG. 1, showing the flow of message processing and delivery to the users of FIG. 1;

FIG. 4 illustrates a flow chart for an exemplary procedure for delivering messages, according to an embodiment;

FIG. 5 illustrates a flow chart for an exemplary procedure of sending at least one of the first message or the second message through the one or more communication channels to the recipients, according to the embodiment of FIG. 4;

FIG. 6 illustrates a computer system that is suitable for implementing an embodiment of at least a portion of various elements of the system of FIG. 1; and

FIG. 7 illustrates a representative block diagram of an example of elements included in circuit boards inside a chassis of the computer of FIG. 6.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Various embodiments include a method for delivering messages. The method can be implemented via execution of computer instructions configured to run at one or more processing modules and configured to be stored at one or more non-transitory memory storage modules. The method can include receiving a message configuration. The message configuration can include an inputted message, one or more targeting filters, one or more triggering conditions, and one or more channel selections. The inputted message can have a first message format. The method also can include selecting one or more recipients from among users based on the one or more targeting filters and first profile information about the users. The method additionally can include determining one or more communication channels for delivery of the messages to the one or more recipients based on the one or more channel selections and second profile information about each of the one or more recipients. The method further can include adapting the inputted message for delivery in the first message format and a second message format different from the first message format. The messages can include the inputted message in the first message format and a second message in the second message format. The method additionally can include determining when to send a first message and the second message based on the one or more triggering conditions. The first message can include the inputted message. The method further can include sending at least one of the first message or the second message through the one or more communication channels to the one or more recipients.

A number of embodiments can include a system for delivering messages. The system can include one or more processing modules and one or more non-transitory memory storage modules storing computing instructions configured to run on the one or more processing modules and perform various acts. The acts can include receiving a message configuration. The message configuration can include an inputted message, one or more targeting filters, one or more triggering conditions, and one or more channel selections. The inputted message can have a first message format. The acts also can include selecting one or more recipients from among users based on the one or more targeting filters and first profile information about the users. The acts additionally can include determining one or more communication channels for delivery of the messages to the one or more recipients based on the one or more channel selections and second profile information about each of the one or more recipients. The acts further can include adapting the inputted message for delivery in the first message format and a second message format different from the first message format. The messages can include the inputted message in the first message format and a second message in the second message format. The acts additionally can include determining when to send a first message and the second message based on the one or more triggering conditions. The first message can include the inputted message. The acts further can include sending at least one of the first message or the second message through the one or more communication channels to the one or more recipients.

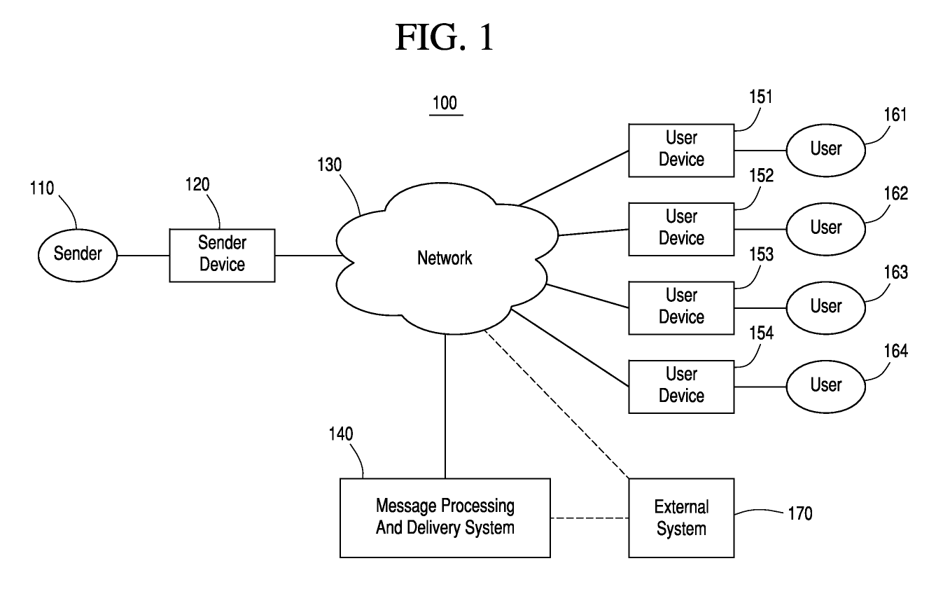

Turning to the drawings, FIG. 1 illustrates a block diagram of an exemplary system 100, all or portions of which can be employed for message notification, according to an embodiment. System 100 is merely exemplary, and embodiments of the system are not limited to the embodiments presented herein. The system can be employed in many different embodiments or examples not specifically depicted or described herein. In some embodiments, certain elements or modules of system 100 can perform various procedures, processes, and/or activities. In other embodiments, the procedures, processes, and/or activities can be performed by other suitable elements or modules of system 100.

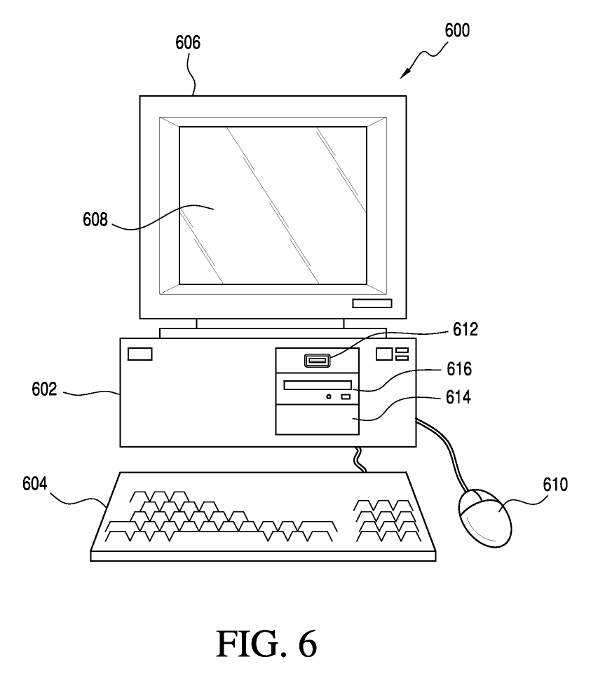

In many embodiments, system 100 can include a sender device 120, a message processing and delivery system 140, an external system 170, and one or more user devices 151-154. In some embodiments, sender device 120 can be used by a sender 110 to create and/or specify information regarding a message to be sent to one or more users, such as users 161-164, through message processing and delivery system 140 and user devices 151-154. In some embodiments, sender device 120 and/or user devices 151-154 can be tablet computing devices, smart phones, laptop computers, desktop computers, and/or other endpoint devices, and can be similar or identical to computer system 600 (FIG. 6), as described below. In several embodiments, sender 110 can be a system operator, such as an owner and/or operator of sender device 120. In many embodiments, sender 120 can define and/or configure a message to be sent to one or more of the users (e.g., 161-164). Users 161-164 and corresponding user devices 151-154 are merely exemplary, and there can be additional or fewer users and/or user devices. Each user can have one or more user devices (e.g., 151-154).

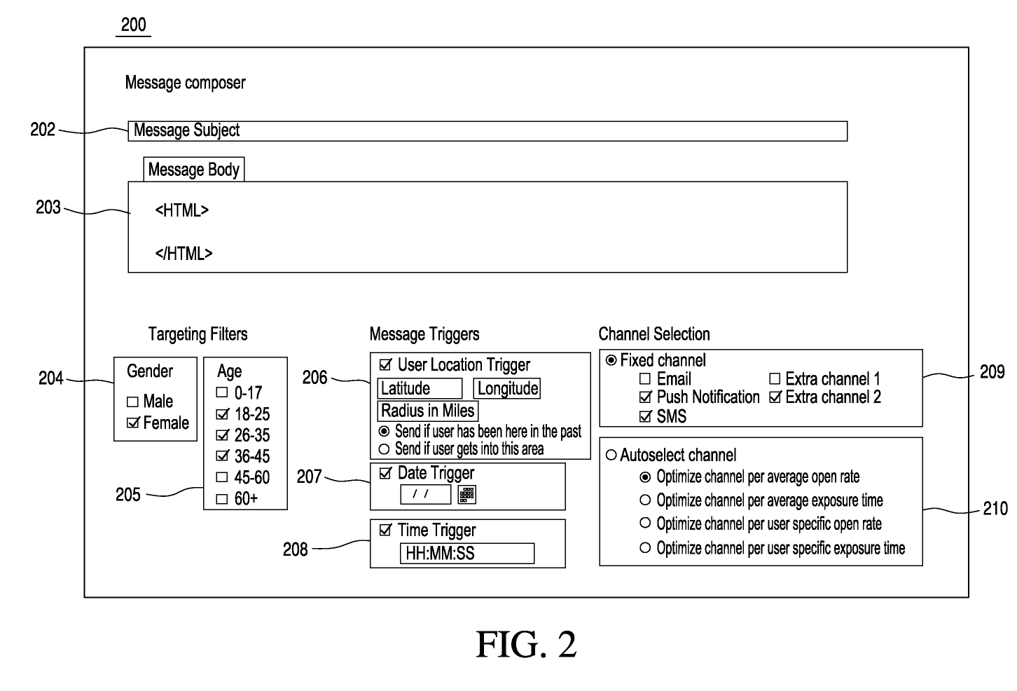

In many embodiments, sender device 120 can present a user interface, such as shown in user interface display 200 (FIG. 2), as described below, to sender 110, which can allow sender 110 to create and/or specify information regarding a message to be sent to one or more users (e.g., such as users 161-164). In some embodiments, the user interface can reside on sender device 120 in the form of a stand-alone application. In other embodiments, the user interface can be presented on sender device 120 through a network-based server, such as through a web browser. The user interface on sender device 120 can be displayed on a visual display of sender device 120. The user interface can facilitate composing and/or configuration of the delivery of the messages sent through message processing and delivery system 140, as described below in further detail.

In several embodiments, message processing and delivery system 140 can be all or a portion of, reside on, and/or operate on a computer system, such as computer system 600 (FIG. 6), as described below, which can be a single computer, a single server, a cluster or collection of computers or servers, or a cloud of computers or servers. For example, in some embodiments, message processing and delivery system 140 can be a stand-alone system. In other embodiments, message processing and delivery system 140 can be part of a larger system, such as one or more modules of a larger system.

In many embodiments, message processing and delivery system 140 can be in data communication with sender device 120 and/or user devices 151-154 through a network 130. In a number of embodiments, network 130 can be a local area network (LAN), a wireless LAN, a wide area network (WAN), a mobile telecommunications wireless data network, the Internet, another suitable network, or a combination thereof. In several embodiments, network 130 can provide digital communication channels, such as through one or more digital communication channel protocols. In some embodiments, sender device 120 and message processing and delivery system 140 can be and/or operate on the same device. In other embodiments, sender device 120 and message processing and delivery system 140 can be and/or operate on different devices, as shown in FIG. 1.

In a number of embodiments, message processing and delivery system 140 can receive the message produced by the user interface, determine the users (e.g., 161-164) to receive the message, determine a communication channel through which to send the message to the user devices (e.g., 151-154), adapt the message to the selected communication channel, and/or deliver the message to the users (e.g., 161-164) through the user devices (e.g., 151-154). For example, message processing and delivery system 140 can determine the communication channel, such as by using statistical and/or user profile information, to deliver a message from sender 120 to one or more users (e.g., 161-164), and/or to adapt the message format and/or content to the selected channel. The message can be sent for any suitable purpose. For example, in one embodiment, the messages can be used for marketing purposes, such as information regarding offers, promotions, discounts, coupons, or other communications, such as commercial communications or business-oriented communications between merchants and consumers. For example, these messages can be used for marketing and/or direct selling purposes. In various embodiments, the messages can be branded messages that can include offers, promotions, discounts, and/or information about merchants and/or companies. In such cases, for example, sender 120 can be a merchant and users 161-164 can be consumers.

In some embodiments, the digital communication channels available through network 130 and/or user devices 151-154 to communicate with users 161-164 can differ in characteristics. For example the communication channels can differ in the amount of information the channel can handle, the ability of the channel to carry rich media, the ability of the channel to reach the users (e.g., 161-164) in any place and/or time, the ability to know if the message was delivered and/or if the message was read, and/or other differentiating characteristics. In some embodiments, message processing and delivery system 140 can accumulate and/or access information about the behavior and/or usage of the users (e.g., 161-164) when the users (e.g., 161-164) use the one or more of the digital communication channels, such as through user devices 151-154. For example, the information can include message reading information, which can include timestamps of when messages are read by the users (e.g., 161-164) on user devices 151-154. In a number of embodiments, the users (e.g., 161-164) can provide information about the location of the user (e.g., 161-164) through systems that are external to message processing and delivery system 140, such as external system 170, and message processing and delivery system 140 can access that information from the external system 170.

In some embodiments, message processing and delivery system 140 can process information and/or statistics about the users (e.g., 161-164) to select the best channel and/or channels through which to send the message, and/or to adapt the message content to the corresponding channel. For example, some content can be trimmed and/or adapted to achieve an effective communication through the selected channel. In some embodiments, sender 110 can define the message to be delivered to include the richest content available to be sent through the selected channel, such that it can be delivered in a full message format through channels that allow rich content, and such that the content can be downgraded to a limited message format for channels that do not allow rich content, as necessary. In some embodiments, the message configuration can include user segmentation definitions such as gender, age, location, communication channel, and/or other suitable definitions. In many embodiments, message processing and delivery system 140 can provide the ability to adapt and select the most suitable channel for delivering the message to the one or more of the users (e.g., 161-164) in a specific moment, and/or the ability to adapt the content of that message to that selected channel. For example, message processing and delivery system 140 can be used to compose and/or automatically deliver messages in the context of online marketing between a merchant and consumers.

In a number of embodiments, external system 170 can be all or a portion of, reside on, and/or operate on a computer system, such as computer system 600 (FIG. 6), as described below, which can be a single computer, a single server, a cluster or collection of computers or servers, or a cloud of computers or servers. For example, in some embodiments, external system 170 can be a stand-alone system. In other embodiments, external system 170 can be part of a larger system, such as one or more modules of a larger system. In some embodiments, external system 170 can communicate with message processing and delivery system 140 through network 130. In other embodiments, external system 170 can communicate directly with message processing and delivery system 140. In yet other embodiments, external system 170 and message processing and delivery system 140 can be part of the same computer system. In several embodiments, message processing and delivery system 140 can be part of (e.g., a module of) external system 170.

In many embodiments, users 161-164 can be registered users of external system 170. For example, external system 170 can be a customer-facing computer system of a merchant, and users 161-164 can be registered customers of the merchant. In some embodiments, external system 170 can use message processing and delivery system 140 as a message delivery module to deliver messages to users 161-164. For example, the merchant can act as sender 110 to send messages to users 161-164. In some embodiments, external system 170 can partially or fully facilitate administering a loyalty rewards program for the merchant.

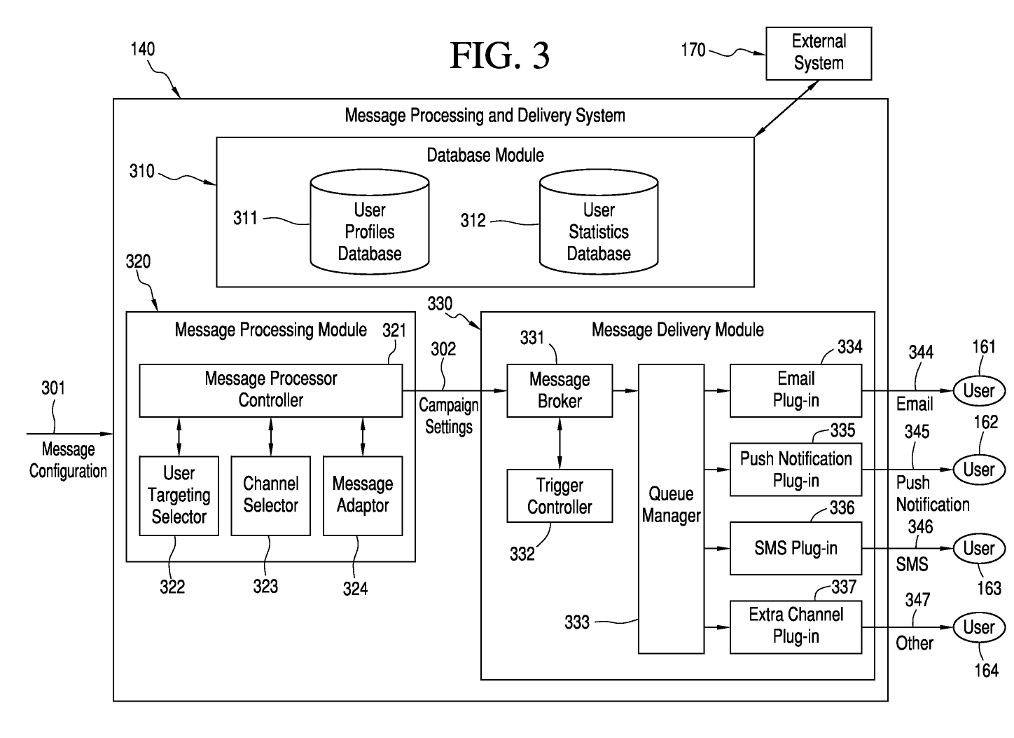

Turning ahead in the drawings, FIG. 2 illustrates an exemplary user interface display 200, as displayed on sender device 120 (FIG. 1), according to an embodiment. User interface display 200 is merely exemplary, and embodiments of the message notification system can be employed in many different embodiments or examples not specifically depicted or described herein. In many embodiments, user interface display 200 can be a display of a graphical user interface. For example, the user interface can be displayed as user interface display 200 to sender 110 (FIG. 1) on sender device 120 (FIG. 1), such as from a website, a mobile application, a tablet application, a computer program, or another suitable mechanism. In a number of embodiments, user interface display 200 can be used by sender 110 (FIG. 1) to define the message configuration (e.g., message configuration 301 (FIG. 3), described below). For example, user interface display 200 can be used to compose and/or enter the message and to set parameters that govern delivery of the message, as described below.

In several embodiments, user interface display 200 can include a message subject field 202. In a number of embodiments, message subject field 202 can display and/or allow sender 110 (FIG. 1) to input a message subject for the message to be sent. In some embodiments, the message subject can be limited in length, such as up to 130 characters. The message subject can be displayed in various different ways. For example, when the message is delivered through a channel that allows a full message format (e.g., messages greater longer than 140 characters and/or including rich media), the subject can be placed at the topmost part of the communication. For example, for a message sent through the email format, the message subject can be sent in the subject line of the email message. When the message is delivered through a channel that does not allow the full message format and instead allows only a limited message format (e.g., messages shorter than 140 characters and/or with limited media), such as push notification or SMS (Short Message Service), the message subject can be displayed in the communication along with a hyperlink to the message. In some embodiments, the message subject can be mandatory, such that user interface display 200 requires sender 110 (FIG. 1) to enter the message subject in message subject field 202 before sending the message configuration (e.g., message configuration 301 (FIG. 3), described below) to message processing and delivery system 140 (FIG. 1).

In many embodiments, user interface display 200 can include a message body field 203. In several embodiments, message body field 203 can display and/or allow sender 110 (FIG. 1) to input a message body for the message to be sent. In some embodiments, the message body can include a block of text that contains HTML code. The HTML code can be input by the sender 110 (FIG. 1). The HTML code in the message body can be rendered as rich media, such that the message body can contain images, videos, links, text, and/or any media format supported by HTML. In other embodiments, the message body can include text and/or rich content in other formats. In many embodiments, the message body can be optional, such that user interface display 200 can proceed to send the message configuration (e.g., message configuration 301 (FIG. 3), described below) to message processing and delivery system 140 (FIG. 1) with message body field 203 left blank and/or unchanged.

In a number of embodiments, user interface display 200 can include one or more targeting filter fields. The targeting filter fields can display and/or allow sender 110 (FIG. 1) to define targeting filters to be used to target certain users (e.g., 161-164 (FIG. 1)). In many embodiments, the targeting filters can be based on profiles of the users (e.g., 161-164). For example, user interface display 200 can include gender-based targeting filter fields 204, age-based targeting filter fields 205. In other embodiments, user interface display 200 can include other targeting filter fields based on profiles of the users (e.g., 161-164 (FIG. 1)).

Gender-based targeting filter fields 204 can display and/or allow sender 110 (FIG. 1) to define gender-based targeting fields, which can define the message configuration (e.g., message configuration 301 (FIG. 3), described below) such that the message will be sent to users (e.g., 161-164 (FIG. 1)) having the one or more genders specified in gender-based targeting filter fields 204. For example, sender 110 (FIG. 1) can define the message configuration (e.g., message configuration 301 (FIG. 3), described below) such that the users (e.g., 161-164 (FIG. 1)) to which the message will be sent are male-only, female-only, or both.

Age-based targeting filter fields 205 can display and/or allow sender 110 (FIG. 1) to define age-based targeting filters, which can define the message configuration (e.g., message configuration 301 (FIG. 3), described below) such that the message will be sent to users (e.g., 161-164 (FIG. 1)) having the ages specified in age-based targeting filter fields 205. For example, age-based targeting filter fields 205 can include two or more age-range filters, such as 0-17, 18-25, 26-35, 36-45, 45-60, and 60+, and/or other suitable age-range filters. For example, sender 110 (FIG. 1) can define the message configuration (e.g., message configuration 301 (FIG. 3), described below) using age-based targeting filter fields 205 such that the users (e.g., 161-164 (FIG. 1)) to which the message will be sent are ages 18-45, as shown in FIG. 2.

In some embodiments, user interface display 200 can include one or more message trigger fields. The message trigger fields can display and/or allow sender 110 (FIG. 1) to define message triggers, which can be based on the location of the users (e.g., 161-164 (FIG. 1)), based on timing, and/or other suitable triggering conditions. For example, user interface display 200 can include location trigger fields 206, date trigger fields 207, and/or time trigger fields 208. In many embodiments, the message can be sent to one or more users (e.g., 161-164 (FIG. 1)) when the one or more triggering conditions specified in the message trigger fields (e.g., 206-208) are satisfied, as described below in further detail.

In several embodiments, location trigger fields 206 can display and/or allow sender 110 (FIG. 1) to define location-based triggering conditions, which can define the message configuration (e.g., message configuration 301 (FIG. 3), described below) such that the message will be sent to users (e.g., 161-164 (FIG. 1)) when the current or past location of the users (e.g., 161-164 (FIG. 1)) satisfy conditions specified in location trigger fields 206. For example, if location triggering is enabled in location trigger fields 206, sender 110 (FIG. 1) can set a latitude, longitude, and radius, which can define a circular area of influence of the message, centered on the latitude and longitude point and within a radius expressed in miles. In addition to those parameters, sender 110 (FIG. 1) can select one of two options: (1) “Send if the user has been here in the past” or (2) “Send if the user gets into this area.” With the first option, the message can be set with a triggering condition so the message is to be sent immediately to any user (e.g., 161-164 (FIG. 1)) that has ever been in the specified location. With the second option, the message can be set with a triggering condition so the message is sent to a user (e.g., 161-164 (FIG. 1)) only if the user arrives in the location. For example, the location can be set could be Latitude of −34.8231, Longitude of −54.2374, Radius of 4 miles, and the second option, “Send if the user gets into this area.” With these location-based triggering conditions, if a user (e.g., 161-164 (FIG. 1)) ever gets within 4 miles from that particular point, then this message will be sent by message processing and delivery system 140 (FIG. 1) to that user (e.g., 161-164 (FIG. 1)), as long as the other settings for the message configuration (e.g., message configuration 301 (FIG. 3), described below) also apply.

In many embodiments, date trigger fields 207 can display and/or allow sender 110 (FIG. 1) to define date-based triggering conditions, which can define the message configuration (e.g., message configuration 301 (FIG. 3), described below) such that the message will be sent to users (e.g., 161-164 (FIG. 1)) when the current date matches the date specified in date trigger fields 207. For example, if date triggering is enabled in date trigger fields 207, sender 110 (FIG. 1) can set a particular date on which the message is to be delivered. For example, if sender 110 (FIG. 1) intends for the message to be sent on Jan. 1, 2017, then sender 110 (FIG. 1) can enable date triggering and set the date to Jan. 1, 2017 in date trigger fields 207.

In a number of embodiments, time trigger fields 208 can display and/or allow sender 110 (FIG. 1) to define time-based triggering conditions, which can define the message configuration (e.g., message configuration 301 (FIG. 3), described below) such that the message will be sent a single time to users (e.g., 161-164 (FIG. 1)) when the current time matches the time specified in time trigger fields 208. For example, if time triggering is enabled in time trigger fields 208, sender 110 (FIG. 1) can set a particular time (which can include the time zone) on which the message is to be delivered. For example, if sender 110 (FIG. 1) intends for the message to be sent at 2:00 PM, then sender 110 (FIG. 1) can enable time triggering and set the time to 2:00 PM EST (Eastern Standard Time) in time trigger fields 208. In a number of embodiments, if a date is not specified in date trigger fields 207, the message can be sent at the next time the current time is 2:00 PM. Otherwise, the time can be on the date specified in date trigger fields 207.

In some embodiments, user interface display 200 can include one or more channel selection fields. The channel selection fields can display and/or allow sender 110 (FIG. 1) to select one or more communication channels to use for delivering the message, and/or settings for selecting the channels to use. For example, user interface display 200 can include fixed-channel selection fields 209 and/or auto-select channel selection fields 210. In many embodiments, the channel selection fields (e.g., 209-210) can determine which communication channels are to be used to deliver the message defined by sender 110 (FIG. 1) in user interface display 200. Each of the communication channels can be a medium or mechanism for delivery of the message. For example, the communication channels can include Email, SMS, Push Notification, Phone Call, Twitter Direct Message, LinkedIn message, Facebook message, Whatsapp message, and/or other suitable communication channels.

In several embodiments, fixed-channel selection fields 209 can display and/or allow sender 110 (FIG. 1) to define which communication channels to use for delivering the message to the users (e.g., 161-164 (FIG. 1)). If the fixed-channel option is selected in fixed-channel selection fields 209, sender 110 (FIG. 1) can select which of the available communication channels will be used to deliver the message. For example, as shown in FIG. 2, sender 110 (FIG. 1) can select Email, Push Notification, SMS. In some embodiments, extra channels can be supported by message processing and delivery system 140 (FIG. 1)), and those extra channels can be selected by sender 110 (FIG. 1) in fixed-channel selection fields 209. For example, if the communication channels selected in fixed-channel selection fields 209 are Email and Push Notifications only, then the message can be sent to users (e.g., 161-164 (FIG. 1)) through all of these selected communication channels that are available for the users (e.g., 161-164 (FIG. 1)). If a certain user (e.g., 161-164 (FIG. 1)) has Email, Push notifications and SMS available as communication channels, then message processing and delivery system 140 (FIG. 1) can send the user (e.g., 161-164 (FIG. 1)) two messages, one via email and another via Push Notification, but will not send a message through SMS, as that communication channel was not selected in fixed-channel selection fields 209.

In a number of embodiments, auto-select channel selection fields 210 can display and/or allow sender 110 (FIG. 1) to define which form of optimization for message processing and delivery system 140 (FIG. 1) to employ in order to send the message. If the auto-selection channel option is selected in auto-select channel selection fields 210, sender 110 (FIG. 1) can select which optimization option to use, as described below in further detail. For example, if sender 110 (FIG. 1) selects an optimize option of “Optimize channel per average open rate,” then the message can be sent to the best available communication channel for each user (e.g., 161-164 (FIG. 1)), based on the average open rate. For example, if the open rate for SMS is 70%, for Push Notification is 40%, and for email is 20%, then if any profile of a user (e.g., 161-164 (FIG. 1)) establishes that the SMS channel is available, that will be the only communication channel used to send a message to that particular user (e.g., 161-164 (FIG. 1)). If the user (e.g., 161-164 (FIG. 1)) does not have SMS, but has Push Notification, as an available communication channel, then message processing and delivery system 140 (FIG. 1) can deliver the message via Push for that particular user (e.g., 161-164 (FIG. 1)).

In many embodiments, when sender 110 (FIG. 1) has defined the message configuration (e.g., message configuration 301 (FIG. 3), described below) using user interface display 200, the message configuration can be sent to message processing and delivery system 140 (FIG. 1). The message configuration can include the content of the message and the other settings defined user interface display 200, such as to whom, what, and under what conditions to deliver the message. For example, sender 110 (FIG. 1) can use user interface display 200 to set the message configuration such that message processing and delivery system 140 (FIG. 1) can send a message to users (e.g., 161-164 (FIG. 1)) that have ever been in an area that is within 2 miles from a certain restaurant at a known latitude and longitude; the users (e.g., 161-164 (FIG. 1)) are between 23 and 45 years old and are women; the chosen method of communication is SMS and Email; and there are no Date or Time restrictions. Message processing and delivery system will immediately deliver the message via SMS and Email to women between 23 and 45 years old who meet the location triggering condition. Those users (e.g., 161-164 (FIG. 1)) who meet those conditions but have not enabled all those communication channels (for example they have not provided a telephone number for SMS or do not have an email address), will only receive messages for the communication channels that are available.

Turning ahead in the drawings, FIG. 3 illustrates a block diagram of external system 170 and message processing and delivery system 140, showing the flow of message processing and delivery to users 161-164. Message processing and delivery system 140 and the modules therein are merely exemplary and are not limited to the embodiments presented herein. Message processing and delivery system 140 can be employed in many different embodiments or examples not specifically depicted or described herein. In some embodiments, certain elements or modules of message processing and delivery system 140 can perform various procedures, processes, and/or acts. In other embodiments, the procedures, processes, and/or acts can be performed by other suitable elements or modules.

In a number of embodiments, message processing and delivery system 140 can include a database module 310, a message processing module 320, and/or a message delivery module 330. In various embodiments, message processing and delivery system 140 can receive as input the message configuration, such as message configuration 301, as defined by sender 110 (FIG. 1) using user interface display 200 (FIG. 2) and sent by sender device 120 (FIG. 2). In many embodiments, message processing and delivery system 140 can process message configuration 301 and send messages to one or more of the users (e.g., 161-164) based on the setting specified by sender 110 (FIG. 1) using user interface display 200 (FIG. 2).

In several embodiments, database module 310 can include user profiles database 311 and/or user statistics database 312. In many embodiments, user profiles database 311 and/or user statistics database 312 can be read from and/or written to by message processing module 320 and/or message delivery module 330. In certain embodiments, message processing module 320 and message delivery module 330 can read from user profiles database 311 and user statistics database 312, and message delivery module 330, but not message processing module 320, can write to user profiles database 311 and user statistics database 312. In several embodiments, data content in user profiles database 311 and/or user statistics database 312 can be generated at least in part from external system 170.

In a number of embodiments, user profiles database 311 can include user profiles, such as collected personal data, about the users (e.g., 161-164). The data can be generated at least in part by external system 170. A user profile can include information about different login method or methods used by the user (e.g., 161-164) for external system 170. Depending on the login method, different communication channels can be used to reach the user (e.g., 161-164). For example, if the user (e.g., 161-164) connected to external system 170 using Facebook, the user profile of the user (e.g., 161-164) can contain information about the Facebook username of the user (e.g., 161-164), and can include other information derived from the Facebook account, such as the email address, gender, and/or birthdate of the user (e.g., 161-164). With this information, message processing and delivery system 140 can send the user (e.g., 161-164) email messages. If a user (e.g., 161-164) logged in using a telephone number, then message processing and delivery system 140 can be able to send the user (e.g., 161-164) SMS messages. If a user logged in using an application on the user device (e.g., 151-154) of the user (e.g., 161-164), then the system will be able to send the user (e.g., 161-164) push notifications to the application in the user device (e.g., 151-154).

In many embodiments, a user profile in user profiles database 311 can include information regarding the user (e.g., 161-164), such as name, surname, date of birth, email address, telephone number(s), known device(s) (e.g., 151-154 (FIG. 1) (which can include corresponding MAC (media access control) address(es)), one or more applications installed on the device(s), and/or operating system on the device(s) (e.g., Android, iOS, Windows Phone, OSX, etc.). In some embodiments, a user profile in user profiles database 311 can include additional information regarding the user, such as account(s) of loyalty rewards points. For example, the user (e.g., 161-164) can participate in one or more loyalty rewards programs within external system 170. A user profile in user profile database 311 can include information about the balances (e.g., of points) of each of those loyalty program accounts for the user (e.g., 161-164). In a number of embodiments, user profiles database 311 can include information regarding loyalty coupons, such as coupons awarded by various loyalty programs. A user profile in user profile database 311 can include information about each of the coupons available for the user (e.g., 161-164). In several embodiments, a user profile in user profiles database 311 can include social media contact information, such as Twitter ID, Twitter account handle, Facebook ID, Facebook Likes the user has performed within external system 170, Google ID, Google Email, LinkedIn ID, LinkedIn Email, etc.

In a number of embodiments, user statistics database 312 can include detailed user statistics based on the actions of the users (e.g., 161-164). For example, the actions of the users (e.g., 161-164) can be stored in user statistics database 312, such that message processing and delivery system 140 can learn over time about the behavior of the users (e.g., 161-164). In many embodiments, these actions and/or statistics regarding the actions can be generated by the external system 170. In some embodiments, message broker 331 (described below) can generate exposure time and/or message opening actions from the users (e.g., 161-164) and can store that information to user statistics database 312.

In many embodiments, user statistics database 312 can include user location history, such as location data stored in latitude and longitude format or other suitable location data formats. In some embodiments, the user location history data can be provided by external system 170. In several embodiments, information regarding the location of a user (e.g., 161-164) can be determined on the user device (e.g., 151-154) of the user (e.g., 161-164) through GPS (global position system) or other suitable location-based mechanisms and provided to external system 170.

In some embodiments, user statistics database 312 can include user login history. For example, external system 170 can store information to user statistics database 312 regarding what methods the user (e.g., 161-164) employed to login when accessing external system 170.

In several embodiments, user statistics database 312 can include user loyalty point movements history. For example, external system 170 can store information to user statistics database 312 regarding how many loyalty points were earned by the user (e.g., 161-164) and when the user (e.g., 161-164) earned the loyalty points.

In a number of embodiments, user statistics database 312 can include user full message opening history. For example, user statistics database 312 can include information about when the user (e.g., 161-164) opened each message. In many embodiments, this information can be collected for messages displayed to the user (e.g., 161-164) in the full message format (e.g., rich content version), as described below in further detail.

In many embodiments, user statistics database 312 can include user full message exposure time history. For example, user statistics database 312 can include information about how long the user (e.g., 161-164) viewed each message before closing the message. In many embodiments, this information can be collected for messages displayed to the user (e.g., 161-164) in the full message format, as described below in further detail.

In some embodiments, user statistics database 312 can include user limited message click-through history. For example, user statistics database 312 can include information regarding clicks on a message in limited message format, as described below in further detail. For example, user statistics database 312 can include information about what message was clicked, when the message was clicked, and by which user (e.g., 161-164) the message was clicked.

In a number of embodiments, message processing module 320 can include a message processor controller 321, a user targeting selector 322, a channel selector 323, and/or a message adaptor 324. In several embodiments, message processing module 320 can receive as input message configuration 301 and produce as output campaign settings 302. In many embodiments, message processing module 320 can determine which of the users (e.g., 161-164) will receive a message, determine by which of the channels the users (e.g., 161-164) will receive the message, adapt the message for each channel to be used, and/or send this information in campaign settings 302 to message delivery module 330 to deliver the message.

In several embodiments, message processor controller 321 can receive message configuration 301 from user interface display 200 (FIG. 2) and coordinate the generation of campaign settings 302. In some embodiments, message processor controller 321 can send campaign settings 302 to message delivery module 330. In many embodiments, the coordination of the generation of campaign settings 302 can be performed by first calling user targeting selector 322, which can generate a list of users that will receive the message. Next, message processor controller 321 can call channel selector 323 for each of the users (e.g., 161-164) in the list of users provided by user targeting selector 322 to determine one or more channels to use for the sending the message to the user (e.g., 161-164). Next, message processor controller 321 can call message adaptor 324, which can adapt the message for full and/or limited message formats. Finally, message processor controller 321 can generate campaign settings 302 and send campaign settings 302 to message delivery module 330.

For example, a message created in user interface display 200 (FIG. 2) can be sent to men of all ages through fixed-channel SMS. Message processing module 320 can receive message configuration 310 containing this information at message processor controller 321. If there are ten users in user profile database 311, of which five are men, and of which three of those men have a telephone number for SMS lists, the campaign settings can include a list of those three users as message recipients. The campaign settings can also include a full and limited message format of the message.

In several embodiments, user targeting selector 322 can be called by message processor controller 321, and can receive as input at least the portions of message configuration 301 that contain the information defined in the targeting filter fields, such as gender-based targeting filter fields 204 (FIG. 2) and/or age-based targeting filter fields 205 (FIG. 2). In many embodiments, user targeting selector 322 can communicate with user profiles database 311 to extract a list of the subset of the users (e.g., 161-164) that comply with the targeting filters. User targeting selector can return the list of the users that comply with the targeting filers to message processor controller 321.

In various embodiments, channel selector 323 can be called by message processor controller 321, and can receive as input the list of users generated by user targeting selector 322 and/or at least the portions of message configuration 301 that contain the information defined in the channel selection fields, such as fixed-channel selection fields 209 (FIG. 2) and/or auto-select channel selection fields 210 (FIG. 2). In several embodiments, channel selector 323 can access user profiles database 311 and user statistics database 312 to determine which communication channels should be used to send the message to each of the users in the list of users supplied by user targeting selector 322. In many embodiments, channel selector 323 can return to message processor controller 321 the list of users generated by user targeting selector 322 with additional channel list information about which communication channels will be used to send the message to each of the users. In several embodiments, the channel selection can be determined for each user on a per-user basis using the criteria in Table 1 if the fixed channel option was selected in fixed-channel selection fields 209 (FIG. 2), or the criteria in Table 2 if the auto-select channel option was selected in auto-select channel selection fields 210 (FIG. 2). For example, if the fixed-channel option is enabled in fixed-channel selection fields 209, and Email, SMS and Push Notification are each selected as communication channels, then if those three channels are available for a certain user, that user will be sent three messages, one for each of those channels.

TABLE 1

| Fixed- | |
|---|---|
| Channel Option | Criteria for Channel Selection |
| Email | The Email channel is added to the channel list if it is |
| | available for the user. |
| Push | The Push Notification channel is added to the channel |
| Notification | list if it is available for the user. |
| SMS | The SMS channel is added to the channel list if it is |
| | available for the user. |
| Extra channel | The extra channel selected is added to the channel list |
| number N | if it is available for the user. |

TABLE 2

| Auto-Select | |
|---|---|
| Channel Option | Criteria for Channel Selection |
| Optimize channel | One message will be sent to the best available |
| per average | channel for each user, based on the average open |
| open rate | rate, which can be extracted from user statistics |
| | database 312. If the channel with the highest open |
| | rate is not available for this user, then next one |
| | available will be used. |
| | For example, if the open rate for SMS is 70%, for |
| | Push Notification is 40% and for email is 20%, then |
| | if any given user profile allows for SMS, that will |
| | be the only channel used to send a message to that |
| | particular user. If the user does not have SMS, but |
| | does have Push Notification, then the system can |
| | deliver the message via Push Notification for that |
| | particular user. |
| Optimize channel | One message will be sent to the best available |
| per average | channel for each user, based on the average exposure |
| exposure time | time, which can be extracted from user statistic |
| | database 312. If the channel with the highest average |
| | exposure time is not available for the user, then the |
| | next one available will be used. |
| | For example, if the average exposure time is 2 seconds |
| | for a message sent by email and 4 seconds for a |
| | message sent via Push notification, and the Push |
| | Notification channel is available for the user, then |
| | the Push Notification channel will be used. |
| Optimize channel | This option works in the same way as the average |
| per user specific | version above but takes into account each specific |
| open rate | user's own open rate statistics instead of the |
| | average for all the Final users. |
| Optimize channel | This option works in the same way as the average |
| per user specific | version above but takes into account each specific |
| exposure time | user's own exposure time statistics instead of |
| | the average for all the Final users. |

In some embodiments, message adaptor 324 can be called by message processor controller 321, and can receive as input at least the portions of message configuration 301 that contain the message subject and/or message body defined in message subject field 202 (FIG. 2) and/or message body field 203 (FIG. 2). In several embodiments, message adaptor 324 can take into account the presence or absence of a message body in message body field 203 (FIG. 2) to determine if the message is in a limited message format or a full message format. In some embodiments, if message subject field 202 (FIG. 2) included a message subject but message body field 203 (FIG. 2) did not include a message body, message adaptor 324 can determine that the message entered is in limited message format. If message subject field 202 (FIG. 2) included a message subject and message body field 203 (FIG. 2) included a message body, message adaptor 324 can determine that the message entered is in full message format. In many embodiments, message adaptor 324 can adapt the message based on the criteria shown in Table 3, and return to message processor controller 321 a message for a limited channel (e.g., a channel that can only send messages in limited message format, such as SMS or Push Notification) and a message for a full channel (e.g., a channel that can send messages in full message format, such as email). In many embodiments, the limited message format can be messages including only text characters of no more than 140 characters in length. In several embodiments, the full message format can be messages exceeding the limited specifications of the limited message format, such as longer messages, messages including rich media, and/or other additional features.

TABLE 3

| | Limited Message Format for | Full Message Format for |
|---|---|---|
| Format of Message | Limited Channel | Full Channel |
| Limited message | No trimming or downgrading | No trimming or downgrading |
| format (only | occurs. The messages for the | occurs. The messages for the |
| message subject | limited and full channels returned to | limited and full channels returned |
| field 202, not | message processor controller 321 | to message processor controller |
| message body field | are the same, which are the same as | 321 are the same, which are the |
| 203, present) | the input message. | same as the input message. |
| | For example, 140 characters can be | For example, 140 characters can be |
| | sent via SMS channel, so no | sent via SMS channel, so no |
| | trimming is necessary. | trimming is necessary. |
| Full message format | Downgrading is necessary. | No trimming or downgrading |
| (message subject | The message for the limited channel | occurs. The message for the full |
| field 202 and | can include the data in message | channel is displayed as entered. |
| message body field | subject field 202 trimmed after 100 | The data in message subject field |
| 203 present) | characters and a short link of no | 202 is displayed as the message |
| | more than 30 characters added to it. | subject and the data in message |
| | Clicking on that link can open a | body field 203 is displayed as |
| | website that displays the full | the body of the message. |
| | message. | For example, a media rich HTML5 |
| | For example, a media rich HTML | message can be sent via email. No |
| | message can be sent as a Push | trimming is necessary. |
| | Notification. Message subject field | |
| | 202 can be trimmed after 100 | |
| | characters and a short link of no | |
| | more than 30 characters can be | |
| | added (e.g., | |
| | http://getcodabox.com/FYu21709), | |
| | summing up to 130 characters. | |
| | Clicking on the short link can open | |
| | a web browser in which the full | |
| | version of the message can be | |
| | displayed. | |

In various embodiments, campaign settings 320 can define at least a portion of a campaign. A campaign can be a group of messages to be sent to a certain subset of users (e.g., 161-164) via certain channels when certain triggers occur. Message processing module 320 can generate campaign settings 302. Campaign settings 302 can be sent from message processing module 320 to message delivery module 330 for delivery of the messages, such as upon triggering conditions. In many embodiments, campaign settings 302 can include the triggering conditions defined in the message trigger fields, such as location trigger fields 206 (FIG. 2), date trigger fields 207 (FIG. 2), and/or time trigger fields 208 (FIG. 2).

In many embodiments, message delivery module 330 can include a message broker 331, a trigger controller 332, a queue manager 333, an email plug-in 334, a push notification plug-in 335, an SMS plug-in 336, and/or an extra channel plug-in 337. In several embodiments, message delivery module 330 can receive as input campaign settings 302 and generate as output a series of messages through various channels that are sent to user (e.g., 161-164).

In a number of embodiments, message broker 331 can receive campaign settings 302 as input, and can place the messages to be delivered in the queue manager 333. In several embodiments, message broker 331 can send to queue manager 333 those messages to be sent immediately. In many embodiments, message broker 331 can manage communication between queue manager 333 and trigger controller 332 when certain messages need to wait for trigger conditions before being sent.

In various embodiments, trigger controller 332 can control messages that have triggering conditions that were defined in the message trigger fields, such as location trigger fields 206 (FIG. 2), date trigger fields 207 (FIG. 2), and/or time trigger fields 208 (FIG. 2). If location trigger is disabled in location trigger fields 206 (FIG. 2), date triggering is disabled in date trigger fields 207 (FIG. 2), and time triggering is disabled in time trigger fields 208, trigger controller 332 can mark the message to be sent immediately and communicate this information to message broker 331, which in turn can communicate this information to queue manager 333. Otherwise, trigger controller 332 can wait until the triggering condition is satisfied. For example, trigger controller 332 can wait until the triggering condition is satisfied for each message to be sent.

In many embodiments, the options in location trigger fields 206 (FIG. 2), date trigger fields 207 (FIG. 2), and time trigger fields 208 (FIG. 2) can operate as conjunctive conditions, such that each of the triggering conditions must be satisfied in order for the message to be sent. For example, a message can be defined in user interface display 200 (FIG. 2) to be sent if a user ever gets to the area of within 1 mile from the Eiffel tower on the Oct. 10, 2031 at 10:54 a.m. Under these triggering conditions, that particular message will be sent only if all those conditions happen at the same time. In other words, if a user visits the Eiffel tower on another date or at another time, the message will not be sent to that user. Similarly, if the user is 2 miles away from the Eiffel tower at that date and time, then the message will not be sent to that user.

In several embodiments, there can be two main types of triggers: location-based triggers (e.g., defined by location trigger fields 206 (FIG. 2)) and timing-based triggers (e.g., defined by date trigger fields 207 (FIG. 2) and/or time trigger fields 208 (FIG. 2)). In many embodiments, a message can stay in a waiting state until the triggering condition is satisfied. In some embodiments, trigger controller 332 can read (e.g., periodically) data from user statistics database 312 to determine if location-based triggering conditions have been satisfied. For example, if a certain user (e.g., 161-164) enters the area defined in message configuration 301 and the option “Send if user gets into this area” is enabled in location trigger fields 206, then the message can be set to be sent upon trigger controller 322 detecting that the condition has been satisfied. As another example, if a certain user (e.g., 161-164) was ever in the past in the area defined in message configuration 301, and the option “Send if user has been here in the past” is enabled in location trigger fields 206, then the message can be set to be sent immediately. For timing-based triggers (e.g., defined by date trigger fields 207 (FIG. 2) and/or time trigger fields 208 (FIG. 2)), trigger controller 332 can determine if the date and/or time triggering conditions are satisfied, in which case the message can marked to be sent. When the message is marked to be sent, trigger controller 332 can communicate this information to message broker 331, which, in turn, can communicate this information to queue manager 333.

In several embodiments, queue manager 333 can receive from message broker 331 individual messages to be sent immediately. The messages can include information about the users (e.g., 161-164) to be the recipients, the channels to be used, and the limited and/or full formatted versions. In some embodiments, queue manager 333 can manage sending the messages by communicating with the appropriate channel plug-ins (e.g., 334-337), which can send the message through one or more communications channels (e.g., 344-347). In several embodiments, if delivery of the message fails to any user (e.g., 161-164), queue manager 333 can retry delivery of the message. In many embodiments, queue manager 333 can receive from the channel plug-ins (e.g., 334-337) information about the opening, exposure time, and click-through information of the messages, and can store this information in user statistics database 312.

In a number of embodiments, email plug-in 334 can receive messages from queue manager 333 to be sent via email. In several embodiments, email plug-in 334 can send the message to one or more email addresses found in the user profiles in user profiles database 311 for the users (e.g., 161-164) specified to receive the message. In many embodiments, email plug-in 334 can send the message as email 344, which can be a communication in the format of email. In several embodiments, the email channel can support a full and/or limited message format. In a number of embodiments, if the message delivery fails, email plug-in 334 can notify queue manager 333 for future retries. If the message delivery is successful, email plug-in 334 can receive and send information about the opening of the message (e.g., when the message was opened), exposure time (e.g., how long the message was open for viewing), and/or click-through information (e.g., if the user clicked on links in the message) to queue manager 333.

In several embodiments, push notification plug-in 335 can receive messages from queue manager 333 to be sent via push notification. In several embodiments, push notification plug-in 335 can send the message to one or more applications on user devices (e.g., 151-154) found in the user profiles in user profiles database 311 for the users (e.g., 161-164) specified to receive the message. In many embodiments, push notification plug-in 335 can send the message as a push notification 345, which can be a communication sent through the push notification channel to a user device (e.g., 151-154 (FIG. 1), such as a mobile device, such as a smartphone operating iOS, Android, or Windows Phone operating system. In several embodiments, the push notification channel can support only a limited message format. In a number of embodiments, if the message delivery fails, push notification plug-in 335 can notify queue manager 333 for future retries. If the message delivery is successful, push notification plug-in 335 can receive and send information about the opening of the message (e.g., when the message was opened), exposure time (e.g., how long the message was open for viewing), and/or click-through information (e.g., if the user clicked on links in the message) to queue manager 333.

In many embodiments, SMS plug-in 336 can receive messages from queue manager 333 to be sent via SMS. In several embodiments, SMS plug-in 336 can send the message to one or more phone numbers of user devices (e.g., 151-154) found in the user profiles in user profiles database 311 for the users (e.g., 161-164) specified to receive the message. In many embodiments, SMS plug-in 336 can send the message as a SMS 346, which can be a communication sent through the SMS channel to a user device 151-154 (FIG. 1). In several embodiments, the SMS channel can support only a limited message format. In several embodiments, if the message delivery fails, SMS plug-in 336 can notify queue manager 333 for future retries. If the message delivery is successful, SMS plug-in 336 can receive and send information about the opening of the message (e.g., when the message was opened), exposure time (e.g., how long the message was open for viewing), and/or click-through information (e.g., if the user clicked on links in the message) to queue manager 333.

In various embodiments, extra channel plug-in 337 can receive messages from queue manager 333 to be sent via other possible channels. For example, new channels can be added through extra channel plug-in 337 to expand the capability of message processing and delivery system 140. For example, additional channels can include Facebook, Twitter, LinkedIn, phone call, Whatsapp, Telegram Messenger, and/or other suitable channels, such as channels that provide an application programming interface (API). In several embodiments, extra channel plug-in 337 can send the message to one or extra channels found in the user profiles in user profiles database 311 for the users (e.g., 161-164) specified to receive the message. In many embodiments, extra channel plug-in 337 can send the message through the extra channel as an other message 347 to a user device 151-154 (FIG. 1). In several embodiments, the extra channel can support a full and/or limited message format. In a number of embodiments, if the message delivery fails, extra channel plug-in 337 can notify queue manager 333 for future retries. If the message delivery is successful, extra channel plug-in 337 can receive and send information about the opening of the message (e.g., when the message was opened), exposure time (e.g., how long the message was open for viewing), and/or click-through information (e.g., if the user clicked on links in the message) to queue manager 333.

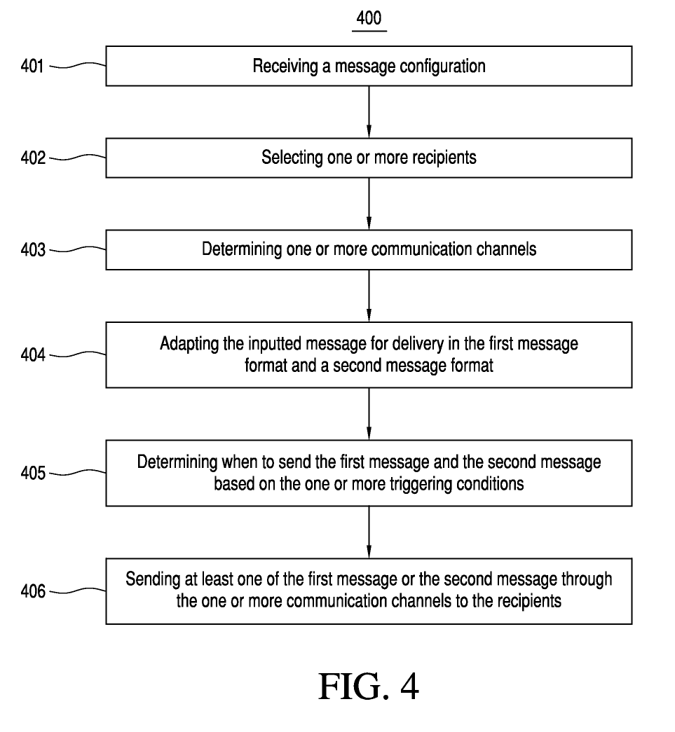

Turning ahead in the drawings, FIG. 4 illustrates a flow chart for a method 400 for delivering messages. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

Referring to FIG. 4, method 400 can include a block 401 of receiving a message configuration. The message configuration can be similar or identical to message configuration 301 (FIG. 3). In several embodiments, the message configuration can include a inputted message, one or more targeting filters, one or more triggering conditions, and one or more channel selections. In a number of embodiments, the inputted message can be similar or identical to the message subject entered in message subject field 202 (FIG. 2) and/or the message body entered in message body field 203 (FIG. 2). In some embodiments, the inputted message can have a first message format. For example, the first message format can be a full message format. In many embodiments, the targeting filters can be similar or identical to the targeting filters entered in gender-based targeting filter fields 204 (FIG. 2) and/or age-based targeting filter fields 205 (FIG. 2). In several embodiments, the triggering conditions can be similar or identical to the message triggers entered in location trigger fields 206 (FIG. 2), date trigger fields 207 (FIG. 2), and/or time trigger fields 208 (FIG. 2). In various embodiments, the channel selections can be similar or identical to the channel selections entered in fixed-channel selection fields 209 (FIG. 2) and/or auto-select channel selection fields 210 (FIG. 2). In a number of embodiments, block 401 can be performed at least in part by message processing module 320 (FIG. 3), and/or through a user interface, such as user interface display 200 (FIG. 2) provided on a sender device, such as sender device 120 (FIG. 1) to a sender, such as sender 110 (FIG. 1).

In many embodiments, method 400 also can include a block 402 of selecting one or more recipients from among users based on the one or more targeting filters and first profile information about the users. The recipients can be similar or identical to users 161-163 (FIGS. 1, 3). In a number of embodiments, the first profile information can be stored in user profiled database 311 (FIG. 1). In some embodiments, the targeting filters can include at least one of age or gender. In some embodiments, the first profile information about the users can include at least one of age-based profile information or gender-based profile information. In several embodiments, block 402 can be performed at least in part by user targeting selector 322 (FIG. 3) of message processing module 320 (FIG. 2).

In a number of embodiments, method 400 additionally can include a block 403 of determining one or more communication channels for delivery of the messages to the recipients based on the one or more channel selections and second profile information about each of the recipients. The one or more communication channels can be similar or identical to the communication channels shown in FIG. 3 (e.g., 344-347 (FIG. 3)). In several embodiments, the second profile information can be stored in user profiled database 311 (FIG. 1). In various embodiments, the second profile information about each of the recipients can further include at least one of open rate statistical information or exposure time statistical information. In many embodiments, block 403 can be performed at least in part by channel selector 323 (FIG. 3) of message processing module 320 (FIG. 3). In some embodiments, the second profile information about each of the recipients can include channel availability information for the recipient.

In various embodiments, method 400 further can include a block 404 of adapting the inputted message for delivery in the first message format and a second message format different from the first message format. In several embodiments, the second message format can be a limited message format. In many embodiments, the messages can include the inputted message in the first message format and a second message in the second message format. In a number of embodiments, block 404 can be performed at least in part by message adaptor 324 (FIG. 3) of message processing module 320 (FIG. 3).

In some embodiments, method 400 additionally can include a block 405 of determining when to send the first message and the second message based on the one or more triggering conditions. In many embodiments, the triggering conditions can include at least one of a specified date, such as a date entered in date trigger fields 207 (FIG. 2), or a specified time, such as a time entered in time trigger fields 208 (FIG. 2). In several embodiments, the triggering conditions can include a specified past location of the recipients, such as a location entered in location trigger fields 206 (FIG. 2) with the option of “Send if the user has been here in the past” in location trigger fields 206 (FIG. 2). In various embodiments, the triggering conditions can include a specified future location of the recipients, such as a location entered in location trigger fields 206 (FIG. 2) with the option of “Send if the user gets into this area” in location trigger fields 206 (FIG. 2). In several embodiments, block 405 can be performed at least in part by trigger controller 332 (FIG. 3) of message delivery module 330 (FIG. 3).

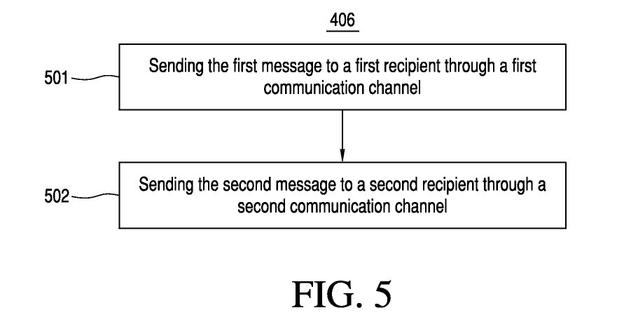

In a number of embodiments, method 400 can further include a block 406 of sending at least one of the first message or the second message through the one or more communication channels to the recipients. In some embodiments, embodiments, block 406 can be performed by one or more modules of message delivery module 330 (FIG. 3). For example, in some embodiments, block 406 can be performed by email plug-in 334 (FIG. 3), push notification plug-in 245 (FIG. 3), SMS plug-in 336 (FIG. 3), and/or extra channel plug-in 337 (FIG. 3). In a number of embodiments, block 406 can be implemented as shown in FIG. 5 and described below.

Turning ahead in the drawings, FIG. 5 illustrates a flow chart for block 406 sending at least one of the first message or the second message through the one or more communication channels to the recipients. Block 406 is merely exemplary and is not limited to the embodiments presented herein. Block 406 can be employed in many different embodiments or examples not specifically depicted or described herein. In some embodiments, the procedures, the processes, and/or the activities of block 406 can be performed in the order presented. In other embodiments, the procedures, the processes, and/or the activities of block 406 can be performed in any suitable order. In still other embodiments, one or more of the procedures, the processes, and/or the activities of block 406 can be combined or skipped.

Referring to FIG. 5, block 406 can include a block 501 of sending the first message to a first recipient of the recipients through a first communication channel of the one or more communication channels. The first communication channel can be one of the communications channels shown in FIG. 3 (e.g., 344-347 (FIG. 3)). In a number of embodiments, the first communication channel can be optimized for the first recipient based on a channel availability for the first recipient and open rate statistical information for the first recipient and/or exposure time statistical information for the first recipient.

In many embodiments, block 406 also can include a block 502 of sending the second message to a second recipient of the recipients through a second communication channel of the one or more communication channels. In several embodiments, the first communication channel can be different from the second communication channel. The second communication channel can be one of the communication channel shown in FIG. 3 (e.g., 344-347 (FIG. 3)). In some embodiments, the second communication channel can be optimized for the second recipient based on (1) a channel availability for the second recipient and (2) open rate statistical information for the second recipient and/or exposure time statistical information for the second recipient. In a number of embodiments, the second recipient can receive the message through the same communication channel as the first recipient. In certain embodiments, there can be additional recipients that receive the message through the first and/or second communication channels, and/or other communication channels. For example, the same communication channel can be used multiple times to deliver the message to various recipients. In several embodiments, the same recipient can receive the message through multiple communication channels, and/or the message can be delivered as a limited format message and/or a full format message.

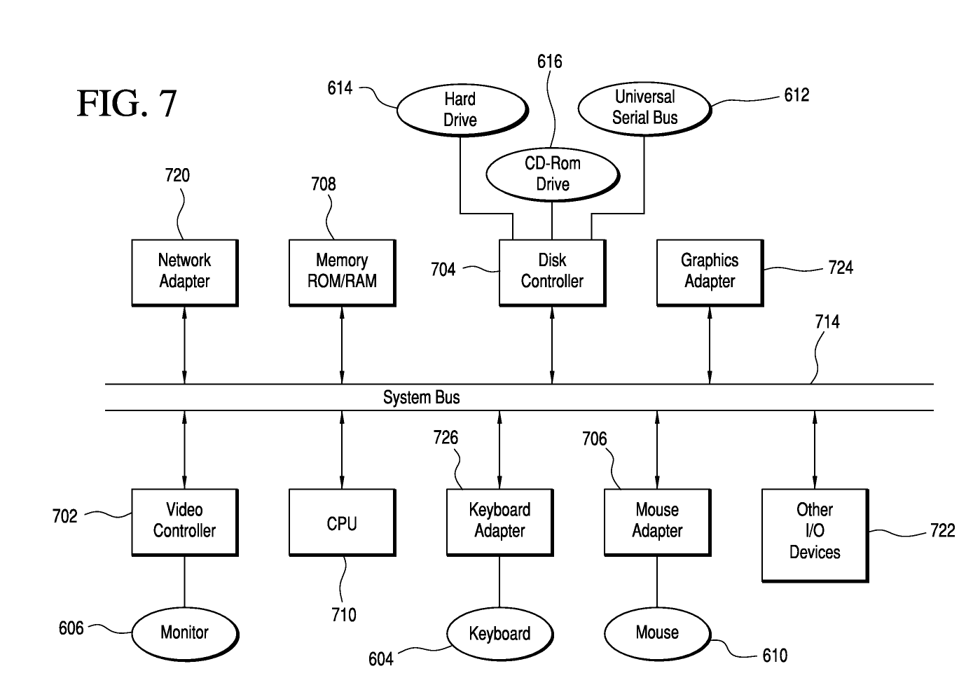

Turning ahead in the drawings, FIG. 6 illustrates a computer system 600, all of which or a portion of which can be suitable for implementing an embodiment of at least a portion of sender device 120 (FIG. 1), user devices 151-154 (FIG. 1), message processing and delivery system 140 (FIGS. 1, 3), and/or external system 170 (FIG. 1), and/or the techniques described in method 400 (FIG. 4) and/or block 406 (FIG. 5). Computer system 600 includes a chassis 602 containing one or more circuit boards (not shown), a USB (universal serial bus) port 612, a Compact Disc Read-Only Memory (CD-ROM) and/or Digital Video Disc (DVD) drive 616, and a hard drive 614. A representative block diagram of the elements included on the circuit boards inside chassis 602 is shown in FIG. 7. A central processing unit (CPU) 710 in FIG. 7 is coupled to a system bus 714 in FIG. 7. In various embodiments, the architecture of CPU 710 can be compliant with any of a variety of commercially distributed architecture families.

Continuing with FIG. 7, system bus 714 also is coupled to memory 708 that includes both read only memory (ROM) and random access memory (RAM). Non-volatile portions of memory storage unit 708 or the ROM can be encoded with a boot code sequence suitable for restoring computer system 600 (FIG. 6) to a functional state after a system reset. In addition, memory 708 can include microcode such as a Basic Input-Output System (BIOS). In some examples, the one or more memory storage units of the various embodiments disclosed herein can comprise memory storage unit 708, a USB-equipped electronic device, such as, an external memory storage unit (not shown) coupled to universal serial bus (USB) port 612 (FIGS. 6-7), hard drive 614 (FIGS. 6-7), and/or CD-ROM or DVD drive 616 (FIGS. 6-7). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 710.

In the depicted embodiment of FIG. 7, various I/O devices such as a disk controller 704, a graphics adapter 724, a video controller 702, a keyboard adapter 726, a mouse adapter 706, a network adapter 720, and other I/O devices 722 can be coupled to system bus 714. Keyboard adapter 726 and mouse adapter 706 are coupled to a keyboard 604 (FIGS. 6 and 7) and a mouse 610 (FIGS. 6 and 7), respectively, of computer system 600 (FIG. 6). While graphics adapter 724 and video controller 702 are indicated as distinct units in FIG. 7, video controller 702 can be integrated into graphics adapter 724, or vice versa in other embodiments. Video controller 702 is suitable for refreshing a monitor 606 (FIGS. 6 and 7) to display images on a screen 608 (FIG. 6) of computer system 600 (FIG. 6). Disk controller 704 can control hard drive 614 (FIGS. 6 and 7), USB port 612 (FIGS. 6 and 7), and CD-ROM or DVD drive 616 (FIGS. 6 and 7). In other embodiments, distinct units can be used to control each of these devices separately.

In some embodiments, network adapter 720 can comprise and/or be implemented as a WNIC (wireless network interface controller) card (not shown) plugged or coupled to an expansion port (not shown) in computer system 600 (FIG. 6). In other embodiments, the WNIC card can be a wireless network card built into computer system 600 (FIG. 6). A wireless network adapter can be built into computer system 600 (FIG. 6) by having wireless communication capabilities integrated into the motherboard chipset (not shown), or implemented via one or more dedicated wireless communication chips (not shown), connected through a PCI (peripheral component interconnector) or a PCI express bus of computer system 600 (FIG. 6) or USB port 612 (FIG. 6). In other embodiments, network adapter 720 can comprise and/or be implemented as a wired network interface controller card (not shown).

Although many other components of computer system 600 (FIG. 6) are not shown, such components and their interconnection are well known to those of ordinary skill in the art. Accordingly, further details concerning the construction and composition of computer system 600 (FIG. 6) and the circuit boards inside chassis 602 (FIG. 6) need not be discussed herein.

When computer system 600 in FIG. 6 is running, program instructions stored on a USB drive in USB port 612, on a CD-ROM or DVD in CD-ROM and/or DVD drive 616, on hard drive 614, or in memory 708 (FIG. 7) are executed by CPU 710 (FIG. 7). A portion of the program instructions, stored on these devices, can be suitable for carrying out all or at least part of the techniques described herein.

Although computer system 600 is illustrated as a desktop computer in FIG. 6, there can be examples where computer system 600 may take a different form factor while still having functional elements similar to those described for computer system 600. In some embodiments, computer system 600 may comprise a single computer, a single server, or a cluster or collection of computers or servers, or a cloud of computers or servers. Typically, a cluster or collection of servers can be used when the demand on computer system 600 exceeds the reasonable capability of a single server or computer. In certain embodiments, computer system 600 may comprise a portable computer, such as a laptop computer. In certain other embodiments, computer system 600 may comprise a mobile device, such as a smartphone. In certain additional embodiments, computer system 600 may comprise an embedded system.

Although the message notification system has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIGS. 4-5 may include different procedures, processes, and/or activities and be performed by many different modules, in many different orders, and/or one or more of the procedures, processes, or activities of FIGS. 4-5 may include one or more of the procedures, processes, or activities of another different one of FIGS. 4-5.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for delivering messages, the method being implemented via execution of computer instructions configured to run at one or more processing modules and configured to be stored at one or more non-transitory memory storage modules, the method comprising:
receiving a message configuration, the message configuration comprising an inputted message, one or more targeting filters, one or more triggering conditions, and one or more channel selections, the inputted message having a first message format;
selecting one or more recipients from among users based on the one or more targeting filters and first profile information about the users;
determining one or more communication channels for delivery of the messages to the one or more recipients based on the one or more channel selections and second profile information about each of the one or more recipients;
adapting the inputted message for delivery in the first message format and a second message format different from the first message format, the messages comprising the inputted message in the first message format and a second message in the second message format;
determining when to send a first message and the second message based on the one or more triggering conditions, wherein the first message comprises the inputted message; and
sending at least one of the first message or the second message through the one or more communication channels to the one or more recipients.

2. The method of claim 1, wherein selecting the one or more one or more recipients from among the users based on the one or more targeting filters and the first profile information about the users comprises:
selecting the one or more recipients from among the users based on the one or more targeting filters and the first profile information about the users such that the one or more targeting filters comprise at least one of age or gender, and the first profile information about the users comprises at least one of age-based profile information or gender-based profile information.

3. The method of claim 1, wherein determining the one or more communication channels for delivery of the messages based on the one or more channel selections and the second profile information about the users comprises:
determining the one or more communication channels for delivery of the messages to the one or more recipients based on the one or more channel selections and the second profile information about each of the one or more recipients, such that the second profile information about each of the one or more recipients comprises channel availability information for the one or more recipients.

4. The method of claim 3, wherein determining the one or more communication channels for delivery of the messages to the one or more recipients based on the one or more channel selections and the second profile information about each of the one or more recipients further comprises:
determining the one or more communication channels for delivery of the messages to the one or more recipients based on the one or more channel selections and the second profile information about each of the one or more recipients, such that the second profile information about each of the one or more recipients further comprises at least one of open rate statistical information or exposure time statistical information.

5. The method of claim 1, wherein adapting the inputted message for delivery in the first message format and the second message format different from the first message format comprises:
adapting the inputted message for delivery in the first message format and the second message format different from the first message format, such that the first message format comprises a full format message and the second message comprises a limited format message.

6. The method of claim 1, wherein determining when to send the first message and the second message based on the one or more triggering conditions comprises:
determining when to send the first message and the second message based on the one or more triggering conditions, wherein the triggering conditions comprise at least one of a specified date or a specified time

7. The method of claim 1, wherein determining when to send the first message and the second message based on the one or more triggering conditions comprises:
determining when to send the first message and the second message based on the one or more triggering conditions, wherein the triggering conditions comprise a specified past location of the one or more recipients.

8. The method of claim 1, wherein determining when to send the first message and the second message based on the one or more triggering conditions comprises:
determining when to send the first message and the second message based on the one or more triggering conditions, wherein the triggering conditions comprise a specified future location of the one or more recipients.

9. The method of claim 1, wherein sending at least one of the first message or the second message through the one or more communication channels to the one or more recipients comprises:
sending the first message to a first recipient of the one or more recipients through a first communication channel of the one or more communication channels; and
sending the second message to a second recipient of the one or more recipients through a second communication channel of the one or more communication channels,
wherein:
the first communication channel is different from the second communication channel.

10. The method of claim 9, wherein:
the first communication channel is optimized for the first recipient based on a channel availability for the first recipient and at least one of open rate statistical information for the first recipient or exposure time statistical information for the first recipient; and
the second communication channel is optimized for the second recipient based on a channel availability for the second recipient and at least one of open rate statistical information for the second recipient or exposure time statistical information for the second recipient.

11. A system for delivering messages, the system comprising:
one or more processing modules; and
one or more non-transitory memory storage modules storing computing instructions configured to run on the one or more processing modules and perform the acts of:
receiving a message configuration, the message configuration comprising an inputted message, one or more targeting filters, one or more triggering conditions, and one or more channel selections, the inputted message having a first message format;
selecting one or more recipients from among users based on the one or more targeting filters and first profile information about the users;
determining one or more communication channels for delivery of the messages to the one or more recipients based on the one or more channel selections and second profile information about each of the one or more recipients;
adapting the inputted message for delivery in the first message format and a second message format different from the first message format, the messages comprising the inputted message in the first message format and a second message in the second message format;
determining when to send a first message and the second message based on the one or more triggering conditions, wherein the first message comprises the inputted message; and
sending at least one of the first message or the second message through the one or more communication channels to the one or more recipients.

12. The system of claim 11, wherein selecting the one or more one or more recipients from among the users based on the one or more targeting filters and the first profile information about the users comprises:
selecting the one or more recipients from among the users based on the one or more targeting filters and the first profile information about the users such that the one or more targeting filters comprise at least one of age or gender, and the first profile information about the users comprises at least one of age-based profile information or gender-based profile information.

13. The system of claim 11, wherein determining the one or more communication channels for delivery of the messages based on the one or more channel selections and the second profile information about the users comprises:
determining the one or more communication channels for delivery of the messages to the one or more recipients based on the one or more channel selections and the second profile information about each of the one or more recipients, such that the second profile information about each of the one or more recipients comprises channel availability information for the one or more recipients.

14. The system of claim 13, wherein determining the one or more communication channels for delivery of the messages to the one or more recipients based on the one or more channel selections and the second profile information about each of the one or more recipients further comprises:
determining the one or more communication channels for delivery of the messages to the one or more recipients based on the one or more channel selections and the second profile information about each of the one or more recipients, such that the second profile information about each of the one or more recipients further comprises at least one of open rate statistical information or exposure time statistical information.

15. The system of claim 11, wherein adapting the inputted message for delivery in the first message format and the second message format different from the first message format comprises:
adapting the inputted message for delivery in the first message format and the second message format different from the first message format, such that the first message format comprises a full format message and the second message comprises a limited format message.

16. The system of claim 11, wherein determining when to send the first message and the second message based on the one or more triggering conditions comprises:
determining when to send the first message and the second message based on the one or more triggering conditions, wherein the triggering conditions comprise at least one of a specified date or a specified time

17. The system of claim 11, wherein determining when to send the first message and the second message based on the one or more triggering conditions comprises:
determining when to send the first message and the second message based on the one or more triggering conditions, wherein the triggering conditions comprise a specified past location of the one or more recipients.

18. The system of claim 11, wherein determining when to send the first message and the second message based on the one or more triggering conditions comprises:
determining when to send the first message and the second message based on the one or more triggering conditions, wherein the triggering conditions comprise a specified future location of the one or more recipients.

19. The system of claim 11, wherein sending at least one of the first message or the second message through the one or more communication channels to the one or more recipients comprises:
sending the first message to a first recipient of the one or more recipients through a first communication channel of the one or more communication channels; and
sending the second message to a second recipient of the one or more recipients through a second communication channel of the one or more communication channels,
wherein:
the first communication channel is different from the second communication channel.

20. The system of claim 19, wherein:
the first communication channel is optimized for the first recipient based on a channel availability for the first recipient and at least one of open rate statistical information for the first recipient or exposure time statistical information for the first recipient; and
the second communication channel is optimized for the second recipient based on a channel availability for the second recipient and at least one of open rate statistical information for the second recipient or exposure time statistical information for the second recipient.
